(19) United States
(12) Patent Application Publication
(10) Pub. No.: US 2014/0074911 A1
(43) Pub. Date: Mar. 13, 2014

(54) METHOD AND APPARATUS FOR MANAGING MULTI-SESSION

(71) Applicant: SAMSUNG ELECTRONICS CO., LTD., Suwon-si (KR)

(72) Inventors: Min-woo PARK, Hwaseong-si (KR); Dae-hee KIM, Suwon-si (KR); Dae-sung CHO, Seoul (KR)

(21) Appl. No.: 13/925,927

(22) Filed: Jun. 25, 2013

(30) Foreign Application Priority Data
Sep. 12, 2012 (KR) 10-2012-0101148

(51) Int. Cl. H04L 29/06

(52) U.S. Cl. CPC H04L 65/601
USPC 709/203

(57) ABSTRACT

A method of managing sessions between a plurality of cloud servers and a client by a multi-session managing apparatus. The method includes receiving respective screen images of the plurality of cloud servers through a multi-session with the plurality of cloud servers; generating a single bitstream by using the screen images; and transmitting the single bitstream to the client through a single session with the client.

### CROSS-REFERENCE TO RELATED PATENT APPLICATION

This application claims the benefit of Korean Patent Application No. 10-2012-0101148, filed on Sep. 12, 2012, in the Korean Intellectual Property Office, the disclosure of which is incorporated herein in its entirety by reference.

### BACKGROUND

1. Field

Embodiments relate to a method and an apparatus for managing a multi-session between a plurality of cloud servers and a client.

2. Description of the Related Art

In the related art, when a single computer performs various tasks, a multiple workspace technology is used as a method of dividing a space for each respective task. According to the multiple workspace technology of the related art, although a single computer is used, a similar environment to an environment for using a plurality of computers can be realized by dividing a screen on which images are displayed for respective tasks. However, from a hardware point of view, since the multiple workspace technology of the related art is performed on a single computer, the multiple workspace technology is not a process for dividing a work space at a hardware level. In addition, since the multiple workspace technology is performed on a single operating system (OS), two different OSs cannot be managed simultaneously.

Recently, a related art method has been suggested of accessing a plurality of virtual machines that exist on a virtual desktop infrastructure (VDI) virtualization server from a single client by enlarging the concept of the above-described multiple workplace technology. However, in order to access a plurality of virtual machines from a single client, the client of the related art needs to support a multiple accessing function. Further, the client of the related art needs to directly manage a multi-session and to separately process a plurality of pieces of data transmitted through the multi-session. Thus, a load of a client of the related art for access to a plurality of virtual machines is increased.

### SUMMARY

Embodiments provide a method and an apparatus for managing a multi-session, for effectively managing sessions of a client that multi-accesses a plurality of cloud servers.

According to an aspect of an exemplary embodiment, there is provided a method of managing sessions between a plurality of cloud servers and a client by a multi-session managing apparatus, the method including receiving respective screen images of the plurality of cloud servers through a multi-session with the plurality of cloud servers; generating a single bitstream by using the screen images; and transmitting the single bitstream to the client through a single session with the client.

According to another aspect of an exemplary embodiment, there is provided a computer-readable recording medium having recorded thereon a program for executing the above-described method.

According to another aspect of an exemplary embodiment, there is provided an apparatus for managing a multi-session between a plurality of cloud servers and a client, the apparatus including a bitstream generator for generating a single bitstream by using screen images of the plurality of cloud servers, which are received through the multi-session with the plurality of cloud servers; and a network interface for transmitting the single bitstream to the client through a single session with the client.

According to a further aspect of an exemplary embodiment, there is provided a method of managing sessions between a plurality of cloud services and a client by a multi-session managing apparatus, the method including requesting a computing process performed in the plurality of cloud services through a multi-session with the client; performing the computing process requested by the client; outputting respective screen images of the plurality of cloud servers corresponding to a result of the computing process through the multi-session; generating a single bitstream using the respective screen images; and transmitting the single bitstream to the client through a single session with the client.

### BRIEF DESCRIPTION OF THE DRAWINGS

The above and other features and advantages of the present disclosure will become more apparent by describing in detail exemplary embodiments thereof with reference to the attached drawings in which:

FIG. 1 is a diagram illustrating a remote computing system according to an embodiment.

FIG. 2 is a block diagram of a multi-session managing apparatus according to an embodiment.

FIG. 3A is a block diagram of a bitstream generating unit of the multi-session managing apparatus, according to an embodiment.

FIG. 3B is a block diagram of a bitstream generating unit of the multi-session managing apparatus, according to another embodiment.

FIG. 4 is a block diagram of a cloud server according to an embodiment.

FIG. 5 is a block diagram of a client according to an embodiment;

FIG. 6 is a flowchart of a method of managing a multi-session, according to an embodiment;

FIG. 7 shows a configuration of a header of a bitstream, according to an embodiment; and

FIG. 8 is a block diagram of a client according to another embodiment

### DETAILED DESCRIPTION

Hereinafter, the present invention will be described in detail by explaining exemplary embodiments with reference to the attached drawings. As used herein, the term “and/or” includes any and all combinations of one or more of the associated listed items. Expressions such as “at least one of,” when preceding a list of elements, modify the entire list of elements and do not modify the individual elements of the list.

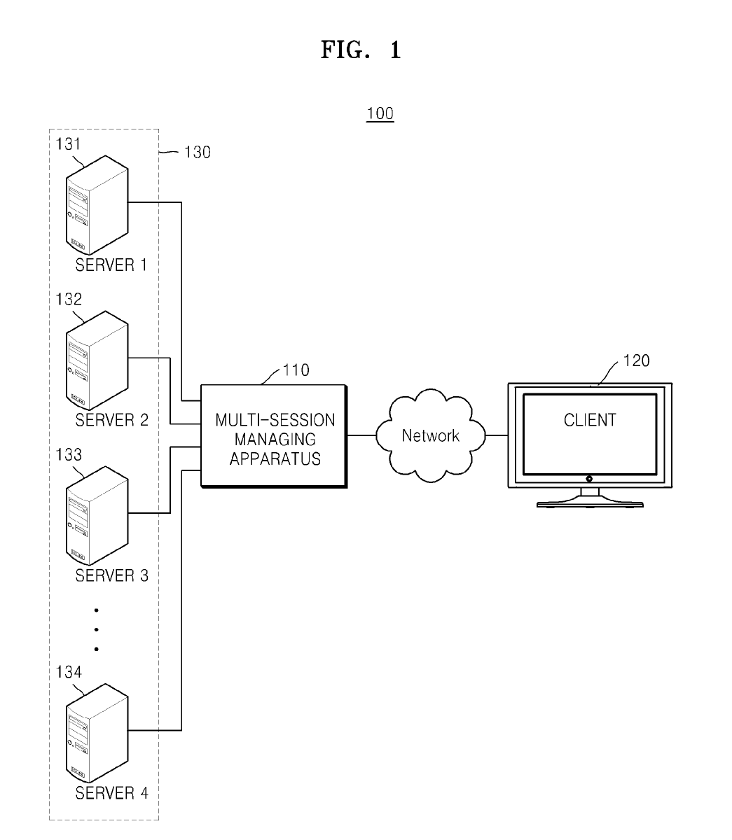

FIG. 1 is a diagram illustrating a remote computing system 100 according to an embodiment. Referring to FIG. 1, the remote computing system 100 includes a plurality of cloud servers 130, a multi-session managing apparatus 110, and a client 120.

The remote computing system 100 provides an on-demand outsourcing service of computing resources through a network according to a request of the client 120. In the remote computing system 100, a service provider may integrate computing resources that exist at different physical positions by using a virtualization technology so as to establish the cloud servers 130 or may generate a plurality of virtual machines on a single server so as to establish the cloud servers 130. The client 120 may not install and use computing resources such as applications, storage, an operating system (OS), security, etc. in the client 120 itself, but may select and use services on a virtual space, which are generated by using a virtualization technology, as much as is desired at a specified point in time.

The client 120 accesses N cloud servers 130 through the Internet and a network including a mobile communication network. The client 120 may be any electronic device capable of accessing the Internet or a mobile communication network, e.g., a desktop computer, a smart TV, a smart phone, a laptop computer, a portable multimedia player (PMP), a tablet personal computer (PC), etc. In addition, the client 120 may be configured in the form of hardware or software contained the aforementioned electronic device. In addition, the client 120 may be configured in a software form on an embedded system. A session that is a logic connecting path for communication exists between the client 120 and a first cloud server 131. Similarly, a single session may also exist between the client 120 and an Nth cloud server 134. Thus, N different sessions exist between the client 120 and the cloud servers 130. The client 120 uses hardware resources of the cloud servers 130 through the N sessions. In other words, the client 120 performs remote computing on the cloud servers 130 through the N sessions, receives a computing result from the cloud servers 130, and displays the computing result.

The cloud servers 130 perform a predetermined computing process requested by the client 120 and capture a screen image corresponding to a result of the computing process. The cloud servers 130 may output and capture a still image, i.e., a frame, but may also output and capture a series of continuous frames. Thus, screen images of the cloud servers 130 may be considered a video. Hereinafter, for convenience of description, it is assumed that screen images are respective frames. However, it would be understood by one of ordinary skill in the art that screen images may refer to a video including continuous frames. In addition, according to another embodiment, a voice signal may be added to a video.

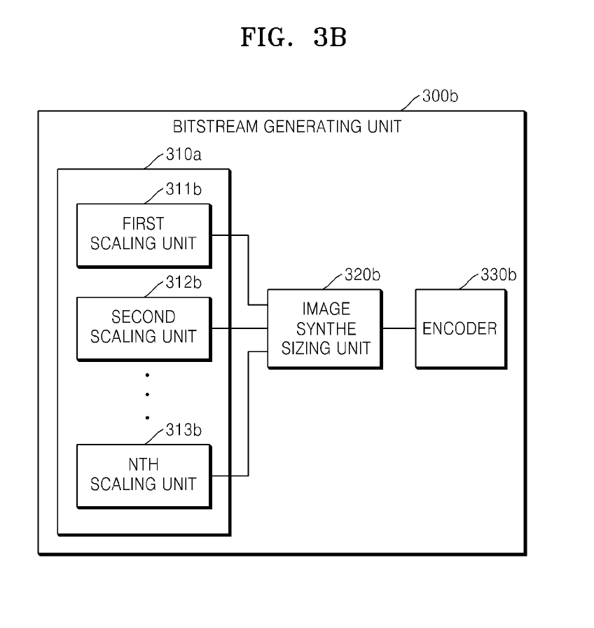

The cloud servers 130 transmit a captured screen image to the client 120 through a network. The cloud servers 130 are embodied as virtual machines. However, some or all of the cloud servers 130 may be embodied as an actual desktop PC. As shown in FIG. 4, respective agents exist in the cloud servers 130. A function of an agent is described with reference to FIG. 4. The agent may exist in the form of hardware or may exist in an operating system (OS). When the agent exists in the OS, the agent may exist in a kernel or on a driver of hardware resources. As another example, the agent may exist in the form of a software program installed on the OS.

The multi-session managing apparatus 110 provides a graphic user interface (GUI) for a multiple access to the cloud servers 130 by the client 120 and manages sessions between the cloud servers 130 and the client 120. For example, the multi-session managing apparatus 110 may connect and disconnect the sessions between the cloud servers 130 and the client 120 to or from each other, may increase and reduce a bandwidth of the sessions, may increase and reduce a transmission speed of the sessions, may manage the connection between the sessions by changing a transmission method, and may compress an image transmitted through the sessions. The multi-session managing apparatus 110 may manage the sessions adaptively to a data processing capability of the client 120, based on information about the data processing capability of the client 120. The data processing capability of the client 120 may be, for example, an image processing capability of the client 120. However, the multi-session managing apparatus 110 may have other data processing capabilities, such as a floating-point arithmetic capability of the client 120, a performance of a central processing unit (CPU) and a memory of the client 120, etc., in addition to the image processing capability. According to embodiments, for convenience of description, it is assumed that the multi-session managing apparatus 110 uses information about the image processing capability of the client 120. However, the scope of the present invention is not limited thereto.

As described below, examples of a case where the multi-session managing apparatus 110 considers the image processing capability of the client 120 may include a case where the multi-session managing apparatus 110 scales screen images of the cloud servers 130, a case where the multi-session managing apparatus 110 adjusts a capturing rate or a frame rate, a case where the multi-session managing apparatus 110 sets the quality of a predetermined screen image on which the client 120 performs tasking to be higher than other screen images. In detail, it is assumed that the client 120 processes 30 sheets of screen images having an X*Y resolution per second and views screen images of four cloud servers 130 (N=4) as if the screen images have the same size. The multi-session managing apparatus 110 may scale all screen images to an X/2*Y/2 resolution such that the client 120 may process 30 sheets of screen images per second. As another method, while the multi-session managing apparatus 110 transmits each screen image having a X*Y resolution to the client 120, the client 120 may adjust a capturing rate or a frame rate of screen images so as to process 7.5 sheets of screen images per second. According to another embodiment, the multi-session managing apparatus 110 may adjust a capturing rate or a frame rate such that the client 120 may process 25 sheets of screen images per second while the multi-session managing apparatus 110 transmits screen images having an X*Y resolution from the first cloud server 131 on which the client 120 performs tasking to the client 120 and may process 5 sheets of screen images per second while the multi-session managing apparatus 110 transmits the remaining screen images having an X*Y resolution to the client 120. According to another embodiment, the multi-session managing apparatus 110 may adjust a capturing rate or a frame rate such that the client 120 may process 25 sheets of screen images per second while the multi-session managing apparatus 110 transmits screen images having an X*Y resolution from the first cloud server 131 on which the client 120 performs tasking to the client 120 and may process 20 sheets of screen images per second while the multi-session managing apparatus 110 transmits the remaining screen images having an X/2*Y/2 resolution to the client 120. According to another embodiment, the multi-session managing apparatus 110 may encode a screen image of the first cloud server 131 on which the client 120 performs tasking, by using an encoding method at a high processing speed, compared with other screen images.

The multi-session managing apparatus 110 supports data sharing between the cloud servers 130 and data transmission/reception between the cloud servers 130. Examples of a case where the multi-session managing apparatus 110 manages sessions will be described below in detail.

N sessions (hereinafter, referred to as ‘multi-session’) exist between the multi-session managing apparatus 110 and the cloud servers 130 and a single session exists between the multi-session managing apparatus 110 and the client 120. The client 120 accesses the multi-session managing apparatus 110, and the multi-session managing apparatus 110 manages the multi-session of the cloud servers 130. Thus, the client 120 does not have to directly manage the multi-session and may perform computing with the plurality of cloud servers 130 as if the client 120 may access a single server.

The multi-session managing apparatus 110 may be separated from the cloud servers 130 and the client 120 and may be embodied in the form of an independent computer. The multi-session managing apparatus 110 may be integrated with the cloud servers 130 and the client 120 to constitute a single device. The multi-session managing apparatus 110 may be embodied as a virtual machine of a virtual desktop infrastructure (VDI) environment, like the cloud servers 130. For example, any one agent of the cloud servers 130 may perform a function of the multi-session managing apparatus 110. The multi-session managing apparatus 110 may exist in the form of software or hardware of a virtualization server generating the cloud servers 130. As another example, the multi-session managing apparatus 110 may exist in the form of software or hardware on a server (not shown) that manages a virtual machine or a virtual machine access.

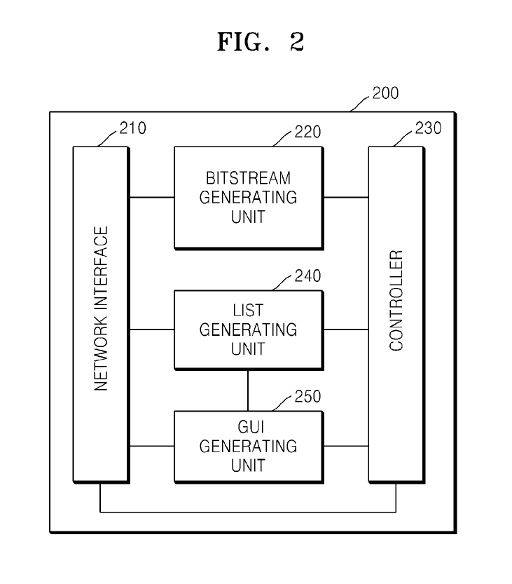

FIG. 2 is a block diagram of a multi-session managing apparatus 200 according to an embodiment. Referring to FIG. 2, the multi-session managing apparatus 200 includes a network interface 210, a bitstream generating unit 220, a list generating unit 240, a graphic user interface (GUI) generating unit 250, and a controller 230.

The network interface 210 forms a multi-session with the cloud servers 130 and forms a single session with the client 120. The multi-session managing apparatus 200 transmits and receives data to and from the cloud servers 130 or the client 120 through the network interface 210. For example, the network interface 210 receives screen images of the cloud servers 130, and the network interface 210 transmits a bitstream generated by the bitstream generating unit 220 to the client 120 through the single session with the client 120. Data that is transmitted and received by the multi-session managing apparatus 200 through the network interface 210 is not limited thereto, and will be described below in detail. The network interface 210 may be embodied according to wired or wireless communication standards.

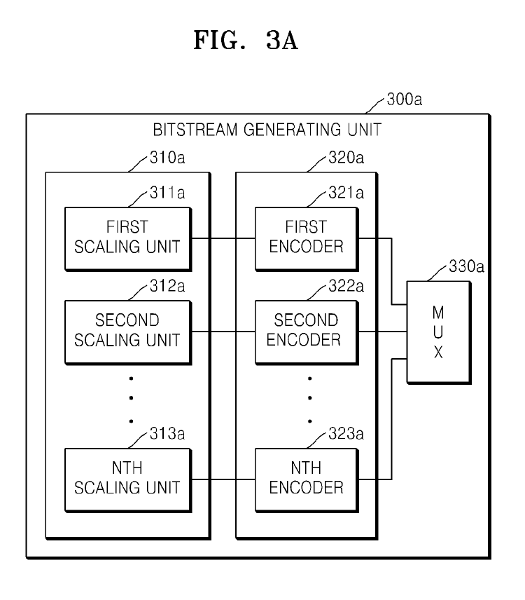

The bitstream generating unit 220 generates one bitstream by using screen images of the cloud servers 130, which are received by the network interface 210 through the multi-session. The bitstream generating unit 220 performs scaling or encoding processes on the received screen images, respectively, or performs an image processing process for synthesizing the screen images into a single screen image and outputs a single bitstream as a result of the image processing process. A detailed structure and operation of the bitstream generating unit 220 will be described below with reference to FIGS. 3A through 3B.

Referring to FIG. 3A, a bitstream generating unit 300a that is an example of the bitstream generating unit 220 includes a scaling unit 310a, an encoding unit 320a, and a multiplexing unit 330a.

The scaling unit 310a performs scaling on the screen images of the cloud servers 130, which are received through the network interface 210. The scaling unit 310a may include N scaling units 311a through 313a in order to perform scaling processes on screen images in parallel to each other. For example, a first scaling unit 311a performs scaling on a screen image of the first cloud server 131 and a second scaling unit 312a performs scaling on a screen image of a second cloud server 132 in parallel. On the other hand, the scaling unit 310a may perform scaling on all screen images in series through a single scaling unit. The scaling unit 310a may perform scaling on screen images to have different scaling rates in a horizontal direction and a vertical direction. For example, the scaling unit 310a may perform scaling on screen images M times in a horizontal direction and N times in a vertical direction. The scaling unit 310a may perform scaling on screen images of different cloud servers 130 according to different scaling rates. In other words, the scaling unit 310a may perform scaling on screen images to have different scaling rates for respective sessions of the multi-session. For example, when the client 120 currently performs tasking on the first cloud server 131, the client 120 performs scaling such that a screen image of the first cloud server 131 may have a greater size than screen images of the remaining cloud servers 132 through 134.

The scaling unit 310a may receive a scaling rate from the client 120. The client 120 may input scaling rates of a predetermined screen image in horizontal and vertical directions directly to a human interface device (HID). As another example, the client 120 may input a scaling rate through mouse dragging on a window of any one displayed screen image.

According to another embodiment, the scaling unit 310a may receive a scaling rate from the controller 230 of the multi-session managing apparatus 200 shown in FIG. 2. The controller 230 may determine a scaling rate, based on information about the image processing capability of the client 120, information about a region of a screen of the client 120, on which the screen images are positioned, or the number of cloud servers 130 that the client 120 accesses. Examples of the information about the image processing capability of the client 120 may include a display resolution of the client 120, the size of an image that is decoded by the client 120 for a time unit, and the size of an image that is rendered by the client 120 for a time unit. The multi-session managing apparatus 200 may receive the information about the image processing capability of the client 120 from the client 120.

The controller 230 of the multi-session managing apparatus 200 shown in FIG. 2 may determine different scaling rates for respective sessions of the multi-session. For example, if it is assumed that the client 120 currently performs tasking on the first cloud server 131, the controller 230 may determine a scaling rate such that a screen image of the first cloud server 131 may have a greater size than sizes of screen images of the remaining cloud servers 132 through 134. A process for determining a scaling rate by the controller 230, in consideration of the image processing capability, will be described by an example. If it is assumed that N screen images received by the multi-session managing apparatus 200 from the cloud servers 130 have an X by Y resolution, the client 120 displays the N screen images from the cloud servers 130 on a single screen, and processes an image having a 4X by 4Y resolution by as much as P frames per second. In this case, the controller 230 may divide a display resolution of the client 120 by a resolution of a screen image to determine a scaling rate in horizontal and vertical directions as 4/N. The above-described case has been described for convenience of description, and the scope of the embodiments is not limited thereto.

Referring back to FIG. 3A, the scaling unit 310a provides the scaled screen images to the encoding unit 320a. The bitstream generating unit 300a may not include the scaling unit 310a. The structure of the bitstream generating unit 300a that does not include the scaling unit 310a is obviously understood by one of ordinary skill in the art based on the aforementioned description. In this case, as shown in FIG. 4, an agent 420 of a cloud server 400 may include a scaling unit 422. The scaling unit 422 of the cloud server 400 may perform the same function as that of the scaling unit 310a of the bitstream generating unit 300a. However, the controller 230 of the multi-session managing apparatus 200 may transmit a determined scaling rate to the cloud server 400 through the network interface 210.

The encoding unit 320a respectively encodes screen images provided from the scaling unit 310a. If the scaling unit 310a is not included in the bitstream generating unit 300a, the encoding unit 320a may encode original screen images that are not scaled or may encode a screen image that is scaled by the cloud server 400. The encoding unit 320a may encode the screen images based on the information about the image processing capability of the client 120. In this case, as described above, examples of the information about the image processing capability of the client 120 may include a display resolution of the client 120, the size of an image that is decoded by the client 120 for a time unit, and the size of an image that is rendered by the client 120 for a time unit.

The encoding unit 320a may use different encoding parameters or different encoding methods according to the image processing capability of the client 120. For example, the encoding unit 320a receives information about an encoding parameter or an encoding method from the controller 230 of the multi-session managing apparatus 200 shown in FIG. 2 and encodes screen images based on the information. The controller 230 may include a lookup table (not shown) in order to determine an encoding parameter or an encoding method according to the image processing capability of the client 120. The controller 230 may determine an encoding parameter corresponding to the information about the image processing capability of the client 120 with reference to the lookup table and may provide the encoding parameter to the encoding unit 320a. For example, the lookup table defines an encoding parameter corresponding to a predetermined display resolution, a decoding speed, or a rendering speed. Examples of the encoding parameter may include a quantization parameter, a chroma subsampling format, a bit-depth, an encoding error rate, an encoding tool, etc. The controller 230 determines a coding method suitable for the image processing capability of the client 120 from among a lossless coding method and a lossy coding method with reference to a lookup table (not shown). The controller 230 may determine an encoding parameter or an encoding method for each respective session of the multi-session. Similar to the aforementioned method of determining a scaling rate, the controller 230 may determine an encoding parameter or an encoding method such that a screen image of the first cloud server 131 on which the client 120 currently performs tasking may have less deteriorating image quality or less encoding loss than screen images of the remaining cloud servers 132 through 134.

The encoding unit 320a may include N encoders 321a through 323a in order to encode N screen images in parallel to each other. For example, a first encoder 321a encodes a screen image of the first cloud server 131 and a second encoder 322a encodes a screen image of the second cloud server 132. On the other hand, the encoding unit 320a may encode all screen images in series by using any one encoder.

The encoding unit 320a may perform predictive coding between screen images of different cloud servers 130. In other words, different encoders 321a through 323a may perform predictive coding with reference to each other. The encoding unit 320a may perform predictive coding between screen images that are received at a time lag in a predetermined session of the multi-session.

The bitstream generating unit 300a may not include the scaling unit 310a. Instead, as shown in FIG. 4, the agent 420 of the cloud server 400 may include the scaling unit 422. The scaling unit 422 of the cloud server 400 may perform the same function as that of the scaling unit 310a of the bitstream generating unit 300a.

The encoding unit 320a provides encoded screen images to the multiplexing unit 330a. The bitstream generating unit 300a may not include the encoding unit 320a. The structure of the bitstream generating unit 300a that does not include the encoding unit 320a is understood by one of ordinary skill in the art based on the aforementioned description. In this case, as shown in FIG. 4, the agent 420 of the cloud server 400 may include an encoder 423. The encoder 423 of the cloud server 400 may perform the same function as that of the encoding unit 320a of the bitstream generating unit 300a. However, the controller 230 of the multi-session managing apparatus 200 may transmit information about the determined encoding parameter or encoding method to the cloud server 400 through the network interface 210.

The multiplexing unit 330a multiplexes a bitstream of screen images provided from the encoding unit 320a to generate a single bitstream. In other words, the multiplexing unit 330a adds screen images of the cloud servers 130 in the form of one source. The multiplexing unit 330a may add a header to the generated bitstream. The multiplexing unit 330a may insert information about the sequence or size of encoded bitstreams or a region of a screen of the client on which screen images are positioned, the number of screen images, or an identifier for identifying screen images into the header of the bitstream.

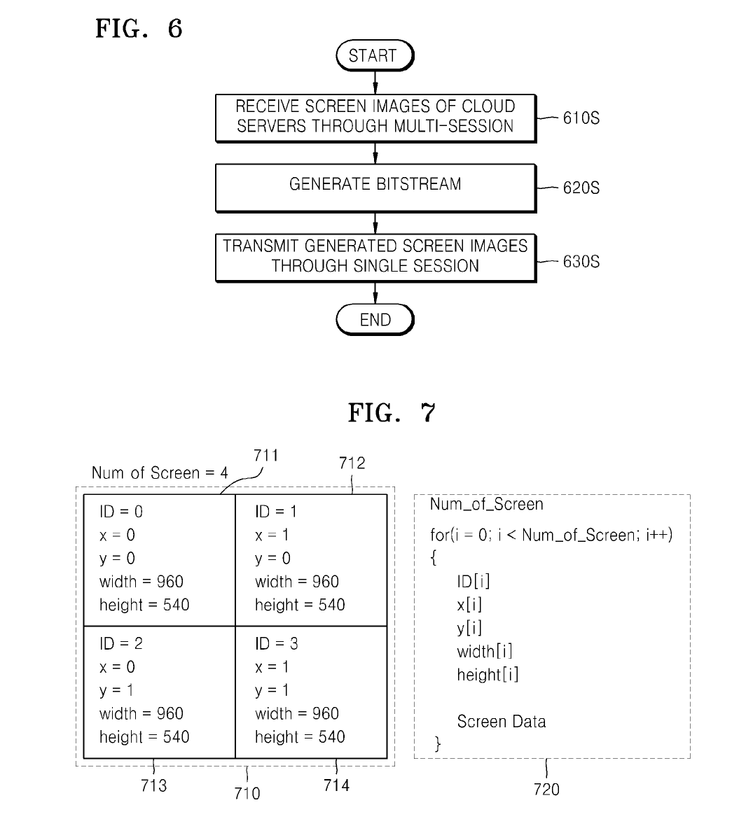

For example, the header of the bitstream may be configured as shown in FIG. 7. Referring to FIG. 7, it is assumed that a resolution of the client 120 is width X height=1920×1080. Screen images 711 through 714 of 4 cloud servers 130 (N=4) are displayed on a screen 710 of the client 120. The screen images 711 through 714 of the cloud servers 130 are arranged on four regions obtained by dividing the screen 710 of the client 120, respectively. Thus, each of the screen images 711 through 714 has a size of 960×540. An identifier ID=0 is assigned to the screen image 711 of the first cloud server 131. Similarly, identifiers ID=1, 2, and 3 are respectively assigned to the remaining screen images 712 through 714. According to the present embodiment, numbers 0 to 3 as identifiers ID are assigned to the screen images 711 through 714, respectively. According to another embodiment, a media access control (MAC) address and/or an internet protocol (IP) address of the cloud servers 130 may be used as an identifier ID. Information about regions where the screen images 711 through 714 are positioned may be expressed as a coordinate value (x, y). Here, x is a coordinate value in a horizontal direction and y is a coordinate value in a vertical direction. An upper-left region of the total four regions may be expressed as (x=0, y=0) and a lower-right region may be expressed as (x=1, y=1). The configuration of a header of the screen 710 of the client 120 may be expressed as a header script 720. In the header script 720, ID[i], x[i], y[i], width[i], and height[i] respectively indicate an array having the same size as that of ‘Num_of_Screen’. The header script 720 shown in FIG. 7 is a just an example for describing the technical feature of the embodiments, and the present invention is not limited thereto.

The client 120 may parse a bitstream header to identify screen images and to render the screen images on appropriate regions. Information about regions of the screen of the client 120 where screen images are arranged may be information that is received from the client 120 by the multi-session managing apparatus 200 or information that is determined by the controller 230 of the multi-session managing apparatus 200.

A bitstream generating unit 300b of FIG. 3B, which is different from the bitstream generating unit 300a shown in FIG. 3A, will be described. For convenience of description, repeated descriptions of FIGS. 1 through 3A will not be given. Thus, the bitstream generating unit 300b is also understood with reference to FIGS. 1 through 3A.

Referring to FIG. 3B, the bitstream generating unit 300b includes a scaling unit 310b, an image synthesizing unit 320b, and an encoder 330b. The scaling unit 310b is substantially the same as the scaling unit 310a shown in FIG. 3A. Thus, a detailed description thereof is omitted.

The image synthesizing unit 320b receives scaled screen images from the scaling unit 310b. The image synthesizing unit 320b synthesizes the screen images received from the scaling unit 310b into a single screen image. The image synthesizing unit 320b may synthesize the screen images into a single screen image by using information about regions of a screen of the client 120 where the screen images are arranged. The information about regions of the screen of the client 120 where screen images are arranged may be information that is received from the client 120 by the multi-session managing apparatus 200 or information that is determined by the controller 230 of the multi-session managing apparatus 200. The screen images synthesized by the image synthesizing unit 320b may include screen images of all or some of the cloud servers 130 and may partially or entirely overlap with each other. The image synthesizing unit 320b provides the single synthesized screen image to the encoder 330b.

The encoder 330b encodes the single synthesized screen image from the image synthesizing unit 320b. The encoder 330b may encode the screen images based on the information about the image processing capability of the client 120. The encoder 330b may use different encoding parameters or different encoding methods according to the image processing capability of the client 120. For example, the encoder 330b receives information about an encoding parameter or an encoding method from the controller 230 of the multi-session managing apparatus 200 shown in FIG. 2 and encodes the single synthesized screen image based on the information. A process for determining an encoding parameter or an encoding method by the controller 230 is understood with reference to FIG. 3A. Examples of the encoding parameter may include a quantization parameter, a chroma subsampling format, a bit-depth, an encoding error rate, an encoding tool, etc.

The encoder 330b may perform predictive coding on a screen image that is subject to current encoding by using a past screen image that is synthesized by the image synthesizing unit 320b.

With regard to the multi-session managing apparatus 200 including the bitstream generating unit 300b shown in FIG. 3B, even if the client 120 performs a multi-access on the plurality of cloud servers 130, the client 120 receives a single screen image through a single session with the multi-session managing apparatus 200. Thus, even if the number of cloud servers 130 that the client 120 accesses is increased, a processing load of the client 120 does not increase.

Referring back to FIG. 2, the controller 230 of the multi-session managing apparatus 200 shown in FIG. 2 controls operations of the network interface 210, the bitstream generating unit 220, the list generating unit 240, and the GUI generating unit 250.

As described with reference to FIG. 3A or 3B, the controller 230 determines a scaling rate of screen images. The controller 230 may determine a scaling rate of screen images by using information about the image processing capability of the client 120. The controller 230 may determine different scaling rates for different screen images. That is, the controller 230 may determine scaling rates for respective sessions of the multi-session. The controller 230 may separately determine scaling rates in horizontal and vertical directions of a screen image. As shown in FIG. 3A or 3B, when the bitstream generating unit 220 performs scaling on screen images, the controller 230 provides the determined scaled rates to the bitstream generating unit 220. On the other hand, when the bitstream generating unit 220 does not include a scaling unit and the cloud server 400 shown in FIG. 4 includes the scaling unit 422, the controller 230 transmits the determined scaling rates to the cloud server 400 through the network interface 210. If different scaling rates are determined for respective sessions of the multi-session, the controller 230 transmits the scaling rates to the sessions of the multi-session, respectively.

As described with reference to FIG. 3A or 3B, the controller 230 determines an encoding parameter or an encoding method of screen images. The controller 230 may determine the encoding parameter or encoding method of the screen images by using the information about the image processing capability of the client 120. As described with reference to FIG. 3A, the controller 230 may determine different encoding parameters for different screen images. In other words, the controller 230 may determine different encoding parameters for respective sessions of the multi-session. As shown in FIG. 3A or 3B, when the bitstream generating unit 220 performs encoding, the controller 230 provides information about the determined encoding parameter or encoding method to the bitstream generating unit 220. On the other hand, when the bitstream generating unit 220 does not perform encoding, and the cloud server 400 includes the encoder 423, as shown in FIG. 4, the controller 230 transmits the information about the determined encoding parameter or encoding method to the cloud server 400 through the network interface 210. If different encoding parameters or encoding methods are determined for respective sessions of the multi-session, the controller 230 transmits information about the encoding parameters or the encoding methods for the respective sessions of the multi-session.

The controller 230 determines a parameter about screen images received from the cloud servers 130. In other words, the controller 230 determines a parameter about the quality of a source. Hereinafter, the parameter will be referred to as a source parameter. For example, the source parameter may refer to a resolution of a screen image, a bit rate, a frame rate, a capturing rate, a bit-depth, etc. The resolution of the screen image refers to a resolution of original screen images output from the cloud servers 130. The bit-depth refers to a bit number assigned to a unit pixel. The frame rate refers to the number of frames that are output from the cloud servers 130 for a time unit. The capturing rate refers to the number of frames that are captured by the cloud servers 130 for a time unit. In other words, some or all screen images that are output according to a predetermined frame rate are captured according to a predetermined capturing rate. The cloud servers 130 may capture a still image, i.e., a frame, but also may output and capture a series of continuous frames. Thus, screen images of the cloud servers 130 may be considered as a video. Accordingly, the quality of screen images may be determined according to a bit rate, similar to a video. The source parameter is just an example. Thus, other parameters may be used.

When the controller 230 determines a source parameter, the controller 230 may consider information about the image processing capability of the client 120, information about a cloud server on which the client 120 performs tasking, information of quality of service (QoS) of sessions, or information of the quality of a screen image requested from the client 120. An example of a case where the controller 230 determines the source parameter in consideration of the information about the image processing capability of the client 120 will be described. It is assumed that the client 120 is capable of processing P frames having an X by Y resolution per second according to the information about the image processing capability of the client 120. In addition, the client 120 displays each of N screen images on the whole screen and quickly changes the screen images. In this case, the controller 230 may determine a resolution of each of the screen images as X by Y, which is a maximum resolution of resolutions displayed by the client 120, and may set a low capturing rate of the screen images. Thus, the controller 230 may determine a capturing rate as P/N or an approximate value of P/N.

The controller 230 may determine a high capturing rate of a screen image of the first cloud server 131 on which the client 120 performs tasking, compared with that of the other cloud servers 132 to 134. Similarly, other source parameters may be determined.

The controller 230 may determine a source parameter in consideration of information about QoS of sessions. The controller 230 may determine the source parameter in consideration of QoS of the multi-session between the cloud servers 130 and the multi-session managing apparatus 200 or QoS of a single session between the client 120 and the multi-session managing apparatus 200. The controller 230 may obtain information about QoS for respective sessions of the multi-session and may respectively determine source parameters for respective sessions. For example, when a bandwidth of a session of the second cloud server 132 is smaller than that of the first cloud server 131, the amount of data transmitted through the session of the second cloud server 132 may be reduced. Thus, the controller 230 may determine a low source parameter of the session of the second cloud server 132, compared with the first cloud server 131.

The controller 230 may determine a source parameter in consideration of information about the quality of a screen image requested by the client 120. For example, when the client 120 requests the controller 230 to change a resolution, the controller 230 increase or reduce a resolution of screen images in response to the request. In addition, when the client 120 requests the controller 230 to capture a particular region of a screen image of a predetermined session, the controller 230 may change a capture region of the session.

The controller 230 requests the cloud servers 130 to provide a screen image according to the determined source parameter. In other words, the controller 230 transmits the determined source parameter to the cloud servers 130 through the network interface 210 to request the cloud servers 130 to change a screen image resolution, a capturing rate, a bit rate, a bit-depth, a frame rate, etc.

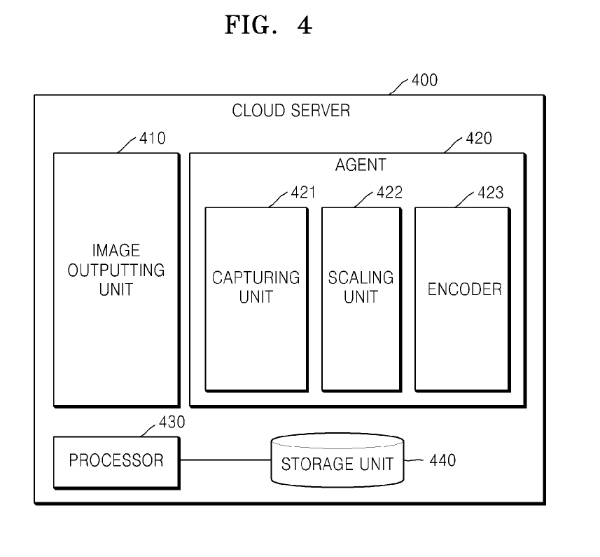

The controller 230 may control a user input of the client 120 for respective sessions of the multi-session. For example, the controller 230 receives a user input formed by a keyboard, a mouse, a touch device, or other input devices of a user of the client 120 through the network interface 210. When screen images displayed on the client 120 are scaled according to a predetermined rate, the controller 230 scales a pointer motion of the client 120 according to this rate and transmits the pointer motion to the cloud servers 130. In addition, in order for the client 120 to use N cloud servers 130 via a single HID interface, the controller 230 may virtualize an HID interface of the client 120 to form N HID interfaces. The N HID interfaces virtualized by the controller 230 control the N cloud servers 130, respectively. The controller 230 may recognize a cloud server on which the client 120 performs tasking, based on, for example, a position of a mouse pointer of the client 120. When a cloud server on which the client 1210 performs tasking is changed, the controller 230 changes a session to which an HID input value of the client 120 is transmitted. As shown in FIG. 5, when a controller 550 of a client 500 includes a tasking session determining unit 551 and an HID input scaling unit 552, the controller 230 of the multi-session managing apparatus 200 may not perform a function for controlling a user input.

The GUI generating unit 250 generates a GUI for multi-accessing the cloud servers 130 from the client 120. When the GUI generating unit 250 generates the GUI, the GUI generating unit 250 may generate an image or a web page based on hypertext markup language (HTML) or Java Script. The GUI generating unit 250 may add a list of the cloud servers 130 and a menu for selecting the cloud servers 130 to the GUI. For example, the client 120 may select some or all of the cloud servers 130 through the GUI and may access the selected cloud server. The GUI generating unit 250 may add a menu for connection and release of sessions of the multi-session and a menu for adjusting the quality of a screen image to the GUI. The GUI generating unit 250 may receive the list of the cloud servers 130 from the list generating unit 240 and may generate the GUI.

The list generating unit 240 generates the list of the cloud servers 130. The list generating unit 240 may generate the list including identifiers or network addresses of the cloud servers 130. Here, for example, a MAC address may be used as an identifier and an internet protocol (IP) address may be used as a network address. The list generating unit 240 may generate the list of the cloud servers 130 that the client 120 is capable of accessing and may provide the list to the GUI generating unit 250. For example, when the cloud servers 130 are virtualization machines on a single physical server, the list generating unit 240 may communicate with the physical server to recognize idle resources and may generate the list of the cloud servers 130 that the client 120 is capable of accessing.

In addition, the list generating unit 240 may generate a list of cloud servers that the client 120 currently accesses. If the number of cloud servers that the client 120 currently accesses is increased or reduced, the list generating unit 240 may update the generated list. The list generating unit 240 may transmit the generated list to the cloud servers 130 through the network interface 210 such that the cloud servers 130 may share data with each other.

The cloud servers 130 may share data with each other and may transmit and receive data by using the identifiers and the network addresses included in the list. For example, as a method of transmitting a file, the client 120 may select a file that is subject to copy from a screen image of the first cloud server 131, may select a predetermined storage region of the second cloud server 132, and may input a copy command. Here, the client 120 may select a file with the mouse on the file of the screen image of the first cloud server 131 and then may input a copy command through a drag-and-drop on a screen image of the second cloud server 132. On the other hand, the client 120 may select a file from the screen image of the first cloud server 131 by using the [Ctrl+C] keys and may input the copy command by adding the file to the screen image of the second cloud server 132 by using the [Ctrl+V] keys. When the cloud servers 130 transmit and receive data, the cloud servers 130 may directly transmit and receive data without via the multi-session managing apparatus 200. On the other hand, the cloud servers 130 may share data with each other or transmit and receive data through the multi-session managing apparatus 200. For example, a case where the client 120 requests the first cloud server 131 to transmit predetermined data stored in the first cloud server 131 to the second cloud server 132 will be described. In this case, the controller 230 of the multi-session managing apparatus 200 may request the first cloud server 131 to transmit predetermined data directly to the second cloud server 132. Alternatively, the controller 230 of the multi-session managing apparatus 200 may receive predetermined data from the first cloud server 131 and then may transmit the data to the second cloud server 132. For example, when the first cloud server 131 and the second cloud server 132 share a clipboard with each other, the multi-session managing apparatus 200 copies the clipboard of the first cloud server 131 into a memory (not shown) of the multi-session managing apparatus 200. Then, the multi-session managing apparatus 200 may read the memory and may transmit the clipboard to the second cloud server 132. Thus, the second cloud server 132 may share the clipboard with the first cloud server 131. When the first cloud server 131 and the second cloud server 132 have different operating systems (OSs) or different file systems, the multi-session managing apparatus 200 may change the clipboard of the first cloud server 131 according to a format of the second cloud server 132 and may transmit the clip board to the second cloud server 132.

The multi-session managing apparatus 200 may further include a storage medium (not shown) for supporting data sharing between the cloud servers 130. For example, the multi-session managing apparatus 200 assigns a shared memory region for data sharing between the cloud servers 130 and authorize some or all of the cloud servers 130 to access the shared memory region. For example, the cloud servers 130 may share the clipboard through the shared memory region. Thus, a text that is subject to a copy command of the client 120 on a screen image of the first cloud server 131 is stored in the shared memory region of the multi-session managing apparatus 200. Thus, when the client 120 inputs a paste command on a screen image of the second cloud server 132, the text is read from the shared memory region. As described above, the multi-session managing apparatus 200 and the cloud servers 130 may be embodied as different virtual machines that exist on a single physical server. In this case, the virtual machines may share a memory and a use policy of a storage medium with each other such that the cloud servers 130 may share data with each other.

An operation of the multi-session managing apparatus 200 when the client 120 accesses the plurality of cloud servers 130 has been described. Hereinafter, an operation of the multi-session managing apparatus 200 when the client 120 releases accesses to the cloud servers 132 to 134 except for the first cloud server 131 will be described. The multi-session managing apparatus 200 may bypass data that is transmitted between the client 120 and the first cloud server 131 through a single session. In other words, since a processing load of the client 120 through a single session is not high, the multi-session managing apparatus 200 may transmit a screen image received from the first cloud server 131 directly to the client 120 without an encoding process, a scaling process, or a process for changing a source parameter. On the other hand, the multi-session managing apparatus 200 may perform the above-described operations, such as an encoding process, a scaling process, or a process for determining and changing a source parameter.

FIG. 4 is a block diagram of the cloud server 400 according to an embodiment. Referring to FIG. 4, the cloud server 400 includes an image outputting unit 410, the agent 420, a processor 430, and a storage unit 440. Hereinafter, repeated descriptions of elements already described above will not be given.

The processor 430 is a central processing device of a cloud server and performs and controls a predetermined calculating process requested by the client 120. The processor 430 may write data to a storage of the storage unit 440 or may read data stored in the storage unit 440 in order to perform a predetermined calculating process.

The storage unit 440 refers to a memory or disc drive of the cloud server 400. As described above, the cloud server 400 may be embodied as a virtual machine and may share data stored in the storage unit 440 with other virtual machines.

The image outputting unit 410 outputs an operational result of the processor 430 to a screen image. The image outputting unit 410 outputs screen images according to a predetermined frame rate, a resolution, a bit-depth, or a bit rate. The frame rate, the resolution, the bit-depth, and the bit rate of the image outputting unit 410 may be changed according to a request of the multi-session managing apparatus 200. As described above, the multi-session managing apparatus 200 determines a source parameter of the cloud server 400 and transmits the source parameter to the cloud server 400. In this case, the agent 420 of the cloud server 400 provides the received source parameter to the image outputting unit 410. Then, the image outputting unit 410 changes a resolution, a frame rate, a bit-depth, or a bit rate of an output screen image, based on the source parameter.

The agent 420 provides the screen image of the cloud server 400 to the client 120 through a session with the multi-session managing apparatus 200. The agent 420 receives a command of the client 120 through the multi-session managing apparatus 200 and controls the cloud server 400 to perform an operation requested by the client 120. In addition, the agent 420 adjusts a resolution, a size, a capturing rate, or the like of the screen image provided to the multi-session managing apparatus 200, according to a request of the multi-session managing apparatus 200.

The agent 420 includes a capturing unit 421, the scaling unit 422, and the encoder 423. The capturing unit 421 captures screen images that are output from the image outputting unit 410, according to a predetermined capturing rate. The capturing unit 421 captures the screen images output from the image outputting unit 410. The capturing unit 421 may receive a capturing rate from the multi-session managing apparatus 200 and may capture a screen image according to the received capturing rate.

The scaling unit 422 may perform the same function as the scaling units 311a to 313a of the scaling unit 310a shown in FIG. 3A. The scaling unit 422 may perform scaling on screen images to have different scaling rates in horizontal and vertical directions. The scaling unit 422 may receive a scaling rate from the multi-session managing apparatus 200 and may perform scaling according to the received scaling rate. The scaling unit 422 may not be included in the agent 420. When the agent 420 includes the scaling unit 422, the bitstream generating unit 300a of FIG. 3A may not include the scaling unit 310a.

The encoder 423 encodes a screen image of the cloud server 400. When the agent 420 includes the scaling unit 422, the encoder 423 receives a scaled screen image from the scaling unit 422. When the agent 420 does not include the scaling unit 422, the encoder 423 receives a captured screen image from the capturing unit 421. The encoder 423 performs the same function as the encoders 321a to 323a of the encoding unit 320a shown in FIG. 3A. The encoder 423 may encode a screen image, based on an encoding parameter of an encoding method, which is received from the multi-session managing apparatus 200. For example, the encoder 423 may receive a quantization parameter, a chroma subsampling format, a bit-depth, an encoding error rate, an encoding tool, or the like as an encoding parameter from the multi-session managing apparatus 200. Since the encoder 423 performs encoding based on the encoding parameter received from the multi-session managing apparatus 200, the encoder 423 may encode a screen adaptively to the image processing capability of the client 120.

Like the scaling unit 422, the encoder 423 may not be included in the agent 420. When the agent 420 includes the encoder 423, the bitstream generating unit 300a may not include the encoding unit 320a. Since the structure and operation of the agent 420 when the agent 420 does not include the encoder 423 or the scaling unit 422 are obviously understood by one of ordinary skill in the art, the structure and operation of the agent 420 when the agent 420 are not repeatedly described.

In order to share a file or clipboard stored in the storage unit 440 with other cloud servers (not shown), the agent 420 may transmit the file or the clipboard to the other cloud serves. The agent 420 may receive a file or a clipboard from other cloud servers and may store the file or the clipboard in the storage unit 440. The file or the clipboard is understood with reference to FIG. 2. The agent 420 may exist in the form of hardware or may exist in an OS of the cloud server 400. When the agent 420 exists in the OS, the agent 420 may exist in a kernel or on a driver of hardware resources. As another example, the agent 420 may exist in the form of a software program installed on the OS.

FIG. 5 is a block diagram of the client 500 according to an embodiment. Hereinafter, repeated descriptions of elements already described above will not be given.

Referring to FIG. 5, the client 500 includes a network interface 510, a decoder 520, a rendering unit 530, a display unit 540, the controller 550, and an HID interface 560.

The network interface 510 receives screen images of the cloud servers 130 through a single session with the multi-session managing apparatus 200. In other words, the network interface 510 receives one bitstream including the screen images of the cloud servers 130 from the multi-session managing apparatus 200. The received screen images are encoded, as described above. The network interface 510 transmits a user command input through the HID interface 560 to the multi-session managing apparatus 200.

The HID interface 560 refers to an interface for receiving a user input through an HID, for example, a mouse, a keyboard, a USB device, or a touch device.

The decoder 520 decodes screen images of the cloud servers 130, which are received through the network interface 510. If the multi-session managing apparatus 200 includes the bitstream generating unit 300a shown in FIG. 3A, the decoder 520 may comprise a plurality of decoders in parallel like the encoders 321a, 322a, 323a shown in FIG. 3A.

The rendering unit 530 renders screen images of the cloud servers 130 on the display unit 540, based on the decoded bitstream. When the multi-session managing apparatus 200 includes the bitstream generating unit 300a shown in FIG. 3A, the rendering unit 530 may recognize information about the sequence or size of bitstreams or a region of a screen of the client 120 on which screen images are positioned, the number of screen images, or an identifier for identifying screen images, with reference to a header of a bitstream. Then, the rendering unit 530 may render the screen images based on the information about the sequence or size of bitstreams or the region of a screen of the client 120 on which screen images are positioned, the number of screen images, or the identifier for identifying screen images. On the other hand, the rendering unit 530 may arrange screen images, based on an input from the HID interface 560.

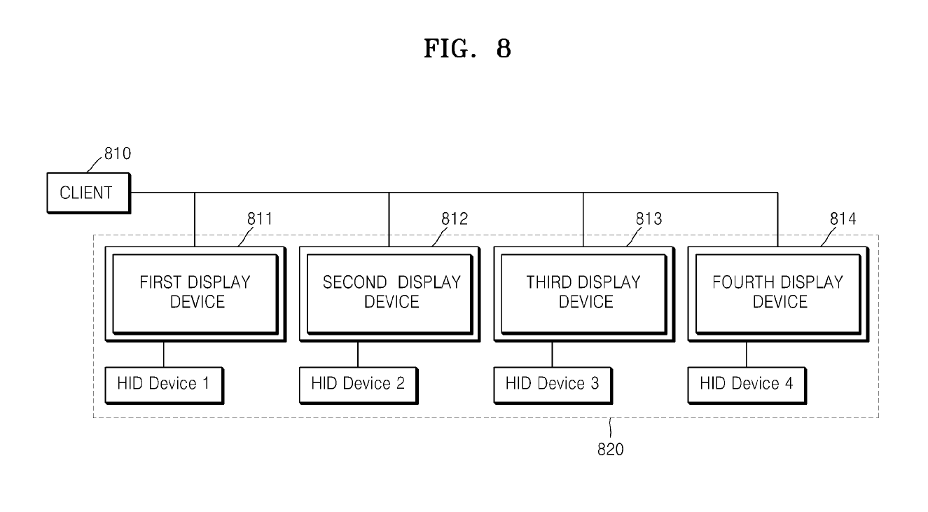

The display unit 540 displays the screen images of the cloud servers 130. As shown in FIG. 8, the display unit 540 may be separated from the client 500 and may be embodied as a display device 820. In addition, as shown in FIG. 8, a single client 810 may be connected to a plurality of display devices 820. The display unit 540 may be embodied as a touch screen. In this case, the display unit 540 and the HID interface 560 may constitute a single unit.

The controller 550 controls an operation of the network interface 510, the decoder 520, the rendering unit 530, the display unit 540, or the HID interface 560. The controller 550 may calculate the amount of data that is capable of being processed by the decoder 520 or the rendering unit 530 for a time unit. In addition, the controller 550 may recognize a resolution set in the display unit 540. The controller 550 may transmit information about the amount of data that is capable of being processed by the decoder 520 or the rendering unit 530 for a time unit or the resolution set in the display unit 540, to the multi-session managing apparatus 200 through the network interface 510.

The controller 550 may include the tasking session determining unit 551 and the HID input scaling unit 552. The tasking session determining unit 551 receives a user input formed by a keyboard, a mouse, a touch device, or other input devices of a user, from the HID interface 560. Then, the tasking session determining unit 551 may recognize a cloud server on which the client 500 performs tasking, based on, for example, a position of a mouse pointer. When screen images are displayed by the display unit 540 according to a predetermined scaling rate, the HID input scaling unit 552 scales a user input formed by keyboard, a mouse, a touch device, or other input devices of a user, which is received from the HID interface 560, according to this scaling rate. Then, the HID input scaling unit 552 transmits the scaled user input to the multi-session managing apparatus 110.

With reference to FIG. 8, a case where the single client 810 is connected to the plurality of display devices 820 will be described. In this case, an internal structure of the client 810 may be obtained from omitting the display unit 540 from the client 500 of FIG. 5. As shown in FIG. 8, the client 810 may receive a user input from a plurality of HID inputting devices through the HID interface 560. In this case, the tasking session determining unit 551 may recognize a screen image that is currently mapped with each HID inputting unit and determines a screen image corresponding to the user input. In FIG. 8, when screen images displayed by the display devices 820 are scaled according to a predetermined scaling rate, the HID input scaling unit 552 scales a user input formed by a keyboard, a mouse, a touch device, or other input devices of a user, which is received from the HID interface 560, according to this scaling rate. Then, the HID input scaling unit 552 transmits the scaled user input to the multi-session managing apparatus 110.

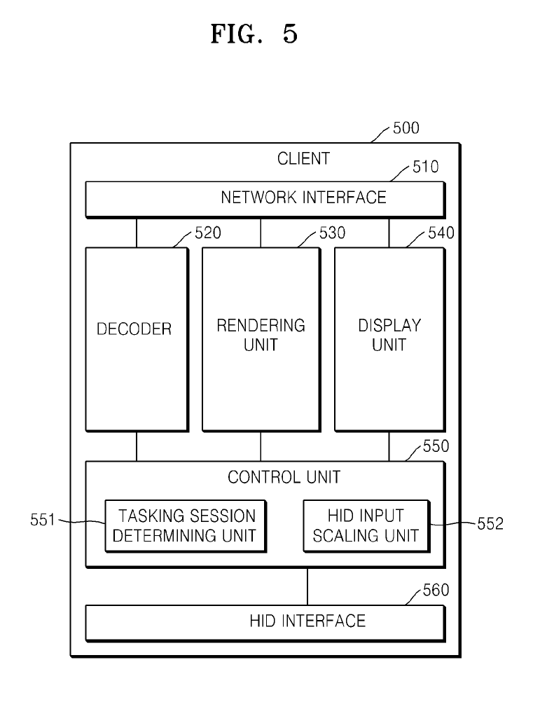

FIG. 6 is a flowchart of a method of managing a multi-session, according to an embodiment. Hereinafter, repeated descriptions will not be given. Thus, the detailed descriptions of FIGS. 1 through 5 apply to the multi-session managing method.

Referring to FIG. 6, the multi-session managing apparatus 200 receives screen images of the cloud servers 130 through a multi-session with the cloud servers 130 (610S). The multi-session managing apparatus 200 generates a single bitstream by using the received screen images (620S).

The multi-session managing apparatus 200 may encode the received screen images, based on information about the image processing capability of the client 120. The information about the image processing capability may include at least one of a size of an image that is decoded by the client 120 for a time unit and a size of an image that is rendered by the client 120 for a time unit. As described with reference to FIG. 3A, the multi-session managing apparatus 200 may encode the screen images for respective sessions of the multi-session and may multiplex the encoded screen images to generate the single bitstream. In this case, information about the sequence or size of encoded bitstreams or a region of a screen of the client 120 on which screen images are positioned, the number of screen images, or an identifier for identifying screen images may be inserted into a header of the bitstream. On the other hand, the multi-session managing apparatus 200 may synthesize the screen images into a single image by using the information about the region of the screen of the client 120 on which screen images are positioned, and may encode the synthesized image to generate a single bitstream, as described with reference to FIG. 3B. In addition, the multi-session managing apparatus 200 may perform predictive coding between screen images of different cloud servers 130. The multi-session managing apparatus 200 may encode the screen images such that an encoding loss of a screen image of the first cloud server 131 on which the client 120 performs tasking may be lower than an encoding loss of the remaining screen images.

The multi-session managing apparatus 200 may determine scaling rates for the respective sessions of the multi-session, based on the information about the image processing capability of the client 120 or the information about the region of the screen of the client 120 where screen images are arranged, and may up-scale or down-scale at least one screen image from among the screen images according to the determined scaling rate.

In addition, the multi-session managing apparatus 200 may determine at least one parameter from among a resolution, a bit rate, a frame rate, and a capturing rate of a screen image for the respective sessions of the multi-session, based on the information about the image processing capability of the client 120. The multi-session managing apparatus 200 may determine a greater parameter as any one parameter of a resolution, a bit rate, a frame rate, and a capturing rate of a screen image of the first cloud server 131 on which the client 120 currently performs tasking, than other screen images. The multi-session managing apparatus 200 may request the cloud servers 130 to transmit screen images according to the parameters determined for the respective sessions.

The multi-session managing apparatus 200 transmits a bitstream to the client 120 through a single session with the client 120 (630S).

The multi-session managing apparatus 200 may generate a list including identifiers and network addresses of the cloud servers 130 and may provide the list to the cloud servers 130 such that the cloud servers 130 may transmit and receive data to and from each other by using the identifiers and the network addresses included in the list. This process may be performed in any operation of 610S to 630S.

The embodiments can be written as computer programs and can be implemented in general-use digital computers that execute the programs using a computer-readable recording medium. Examples of the computer-readable recording medium include magnetic storage media (e.g., ROM, floppy disks, hard disks, etc.), and storage media, such as optical recording media (e.g., CD-ROMs, or DVDs).

Embodiments are not limited to the above disclosure. For example, in FIG. 2, the bitstream generating unit 220, the list generating unit, and the GUI generating unit 250 may each include a processor for performing their respective functions. Further, in FIGS. 3A-3B, the encoding unit 320a, the encoder 330b, the scaling unit 310a, and the multiplexing unit 330a may each include a processor for performing their respective functions. In FIGS. 4-5, the image outputting unit 410, the capturing unit 421, the scaling unit 422, the encoder 423, the decoder 520, the rendering unit 530, the display unit 540, the tasking session determining unit 551, and the HID input scaling unit 552 may each include a processor for performing their respective functions. However, embodiments are not limited. In another exemplary embodiment, a single processor may be used to perform all of the functions of the units in FIGS. 2-5. In a further exemplary embodiment, each of the units in FIGS. 2-5 may be implemented in hardware, such as a hardware interface, a hardware circuit, or a hardware module for performing their respective functions.

According to the one or more embodiments, sessions between a plurality of cloud servers and a client are effectively managed in consideration of a processing capability of the client that multi-accesses the plurality of cloud servers, thereby reducing a processing load of the client.

While the present disclosure has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of managing sessions between a plurality of cloud servers and a client by a multi-session managing apparatus, the method comprising:
receiving respective screen images of the plurality of cloud servers through a multi-session with the plurality of cloud servers;
generating a single bitstream by using the screen images; and
transmitting the single bitstream to the client through a single session with the client.

2. The method of claim 1, wherein the generating of the single bitstream comprises encoding the screen images, based on information about an image processing capability of the client.

3. The method of claim 2, wherein the information about the image processing capability of the client comprises at least one of a resolution of a screen of the client, a size of an image that is decoded by the client for a time unit, and a size of an image that is rendered by the client for the time unit.

4. The method of claim 1, wherein the generating of the single bitstream comprises: synthesizing the screen images into a single image; and encoding the synthesized single image to generate the single bitstream.

5. The method of claim 4, wherein the synthesizing of the screen images comprises synthesizing the screen images by using information about a region of a screen of the client on which the screen images are arranged.

6. The method of claim 1, wherein the generating of the single bitstream comprises performing predictive coding between screen images of different cloud servers.

7. The method of claim 1, wherein the generating of the single bitstream comprises: encoding each of the screen images for respective sessions of the multi-session; and multiplexing the encoded screen images to generate the single bitstream.

8. The method of claim 1, wherein the generating of the single bitstream comprises encoding the screen images such that an encoding loss of a screen image of a cloud server on which the client performs tasking is lower than an encoding loss of remaining screen images, other than the screen image of the cloud server on which the client performs tasking.

9. The method of claim 1, wherein the generating of the single bitstream comprises inserting information about a region of a screen of the client where the screen images are arranged into a header of the single bitstream.

10. The method of claim 1, wherein the generating of the single bitstream comprises determining scaling rates for respective sessions of the multi-session, based on information about an image processing capability of the client or information about a region of a screen where the screen images are arranged; and
up-scaling or down-scaling at least one screen image from among the screen images according to the determined scaling rates.

11. The method of claim 1, further comprising determining at least one parameter from among a resolution, a bit rate, a frame rate, and a capturing rate of a screen image for respective sessions of the multi-session, based on information about an image processing capability of the client.

12. The method of claim 11, wherein the determining of the at least one parameter comprises determining the at least one parameter as any one of the resolution, the bit rate, the frame rate, and the capturing rate of a screen image of a cloud server on which the client currently performs tasking, which is greater than screen images other than the screen image of the cloud server on which the client performs tasking.

13. The method of claim 11, further comprising requesting the plurality of cloud servers to transmit screen images according to the at least one parameter determined for the respective sessions.

14. The method of claim 1, further comprising generating a list including identifiers and network addresses of the plurality of cloud servers.

15. The method of claim 14, further comprising providing the list to the plurality of cloud servers such that data is transmitted and received between the plurality of cloud servers by using the identifiers and the network addresses included in the list.

16. An apparatus for managing a multi-session between a plurality of cloud servers and a client, the apparatus comprising:
a bitstream generator which generates a single bitstream by using screen images of the plurality of cloud servers, which are received through the multi-session with the plurality of cloud servers; and
a network interface which transmits the single bitstream to the client through a single session with the client.

17. The apparatus of claim 16, wherein the bitstream generator comprises an encoder which encodes the screen images, based on information about an image processing capability of the client.

18. The apparatus of claim 16, wherein the bitstream generator comprises: an image synthesizer which synthesizes the screen images into a single image by using information about a region of a screen of the client where the screen images are arranged; and an encoder which encodes the synthesized single image.

19. The apparatus of claim 16, wherein the bitstream generator comprises an encoder which performs predictive coding between screen images of different cloud servers.

20. The apparatus of claim 16, wherein the bitstream generator comprises: an encoder which encodes the screen images for respective sessions of the multi-session; and a multiplexer which multiplexes the encoded screen images to generate the single bitstream.

21. The apparatus of claim 16, wherein the bitstream generator comprises an encoder which encodes the screen images such that an encoding loss of a screen image of a cloud server on which the client performs tasking is lower than an encoding loss of remaining screen images, other than the screen image of the cloud server on which the client performs tasking.

22. The apparatus of claim 16, wherein the bitstream generator inserts information about a region of a screen of the client where the screen images are arranged into a header of the single bitstream.

23. The apparatus of claim 16, further comprising a controller which determines scaling rates for respective sessions of the multi-session, based on information about an image processing capability of the client or information about a region of a screen where the screen images are arranged,
wherein the bitstream generator up-scales or down-scales at least one screen image from among the screen images according to the determined scaling rates.

24. The apparatus of claim 16, further comprising a controller which determines at least one parameter from among a resolution, a bit rate, a frame rate, and a capturing rate of a screen image for respective sessions of the multi-session, based on information about an image processing capability of the client.

25. The apparatus of claim 24, wherein the controller determines the at least one parameter as any one of the resolution, the bit rate, the frame rate, and the capturing rate of a screen image of a cloud server on which the client currently performs tasking, which is greater than screen images other than the screen image of the cloud server on which the client performs tasking.

26. The apparatus of claim 16, further comprising a list generator which generates a list including identifiers and network addresses of the plurality of cloud servers.

27. The apparatus of claim 26, wherein the network interface transmits the list to the plurality of cloud servers such that data is transmitted and received between the plurality of cloud servers by using the identifiers and the network addresses included in the list.

28. A computer-readable recording medium having recorded thereon a program for executing the method of claim 1.

29. A method of managing sessions between a plurality of cloud services and a client by a multi-session managing apparatus, the method comprising:
requesting a computing process performed in the plurality of cloud services through a multi-session with the client;
performing the computing process requested by the client;
outputting respective screen images of the plurality of cloud servers corresponding to a result of the computing process through the multi-session;
generating a single bitstream using the respective screen images; and
transmitting the single bitstream to the client through a single session with the client.

30. The method of claim 29, wherein the computing process is performed by the plurality of cloud servers.
